(19) United States
(12) Patent Application Publication
(10) Pub. No.: US 2026/0246660 A1
(43) Pub. Date: Aug. 20, 2026

(54) ACOUSTIC ECHO CANCELLATION FOR MULTI-MICROPHONE CONFERENCE SYSTEMS

(71) Applicant: Zoom Communications, Inc., San Jose, CA (US)

(72) Inventors: Yifeng Fan, Foster City, CA (US); Qiang Gao, Pineville, NC (US); Zhaofeng Jia, Saratoga, CA (US); Gang Shi, San Jose, CA (US); Wei Wang, Hefei (CN); Xinyu Yao, Hefei (CN)

(73) Assignee: Zoom Communications, Inc., San Jose, CA (US)

(21) Appl. No.: 19/538,423

(22) Filed: Feb. 12, 2026

(30) Foreign Application Priority Data
Feb. 14, 2025 (CN) 202510165715.0

(51) Int. Cl. H04L 12/18; G10L 21/0216

(52) U.S. Cl. CPC H04L 12/1831; G10L 21/0216; G10L 2021/02163

(57) ABSTRACT

Systems and methods of acoustic echo cancelation for a multi-microphone conference system are provided. A video conference device receives an audio signal comprising speech associated with a currently speaking participant during a hybrid communication session. The video conference device includes a dedicated microphone and is communicatively coupled to one or more extended microphones related to one or more local client devices associated with one or more local participants. The video conference device determines whether the currently speaking participant is a remote participant or a local participant based on the speech signal. The video conference device activates, based on whether the currently speaking participant is a remote participant or a local participant, one or more microphones of the dedicated microphone and the one or more extended microphones.

### REFERENCE TO RELATED APPLICATION

This claims the benefit of priority under 35 U.S.C. § 119(a) to Chinese Patent Application No. 202510165715.0, filed Feb. 14, 2025, the entirety of which is hereby incorporated by reference herein.

### FIELD

The present application generally relates to video conferencing and more specifically relates to acoustic echo cancellation (AEC) for multi-microphone conference systems.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides chat and videoconferencing functionalities to various client devices.

FIG. 2 shows an example system in which a chat and video conference provider provides chat and videoconferencing functionalities to various client devices.

FIG. 3 shows an example system that can establish a virtual communication session.

FIG. 4 shows a signal flow associated with a multi-microphone conference system when a remote participant of a video conference is speaking.

FIG. 5 shows an example system that is configured for AEC for a multi-microphone conference system.

FIG. 6 shows an example method of AEC for a multi-microphone conference system.

FIG. 7A shows an example method of adaptive microphone selection for AEC in FIG. 6.

FIG. 7B shows another example method of adaptive microphone selection for AEC in FIG. 6.

FIG. 8 shows an example computing device suitable for use in example systems or methods of AEC for a multi-microphone conference system according to this disclosure.

### DETAILED DESCRIPTION

Examples are described herein in the context of AEC for multi-microphone conference systems. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

A multi-microphone conference system utilizes multiple microphones, including a dedicated microphone in a conference room and extended microphones associated with multiple local client devices to capture audio signals from local participants in a conference room. These microphones work together to enhance audio quality and expand coverage, ensuring better sound delivery for remote meeting participants. However, AEC presents a challenge in multi-microphone systems. Echo occurs when sound played by a speaker device is captured by a microphone and transmitted back to remote participants, creating an unwanted feedback loop. Conventional AEC techniques usually rely on the speaker device's audio as a reference signal to eliminate echo signals. For these AEC techniques to function effectively, the reference signal needs to precede the microphone-captured signal. However, in a multi-microphone system, this requirement may not always be met. The reference signals the local user devices need for canceling the echo signals are provided by the video conference device via the local network, which may have greater latency and cause delay. Thus, the conventional AEC techniques do not work effectively for a multi-microphone conference system.

To address AEC challenges in a multi-microphone conference system, particularly when the reference signal lags behind the microphone-captured signal, it is desirable for the multi-microphone system to intelligently select audio signals from different microphones for echo mitigation.

For example, a video conference device is installed in a conference room, where multiple local participants of a video conference are present. The multiple local participants have their user devices, for example laptops or mobile phones, connected to the video conference device. The user devices are connected to the video conference device over a local network. The video conference device includes a dedicated microphone. The user devices include their own microphones, which may be considered as extended microphones for the video conference device. The video conference device, its dedicated microphone, and the extended microphones form a multi-microphone system. The video conference device collects audio signals from all the microphones to generate high-quality audio output, and delivers the high-quality audio output to remote participants in the video conference. A speaker device associated with the video conference device plays audio signals from a remote participant to allow local participants in the conference room to hear the remote participant. The audio played by the speaker device is captured by both the dedicated microphone of the video conference device and the extended microphones from the user devices in the conference room, all of which can send the echo signals back to the remote participants, causing audio feedback.

The video conference device includes an AEC model configured to cancel the echo signal captured by the extended microphone. The AEC model uses the audio signal received from the remote participant as a reference signal, which is received prior to the echo signal captured by the extended microphone. The AEC model then correlates the echo signal with the reference signal, for example using a Pearson correlation formula, to determine if the echo signals and the reference signal are in a linear relationship. If so, the AEC module cancels the echo signal.

However, if a local user device or an extended microphone in the multi-microphone conference system includes an AEC model, such an AEC model may not be able to cancel echo signals as effectively as the AEC model in the video conference device. The reference signals the local user devices need for canceling the echo signals are provided by the video conference device via the local network. The AEC models on the user devices may receive the reference signals after the extended microphones receive the echo signals. Thus, an AEC module in a local user device using conventional AEC techniques may not work properly for effective AEC.

The present disclosure provides microphone selection techniques to dynamically adapt microphone usage based on voice activity detection to prevent echo signals from the extended microphones. If the video conference device detects speech signals from a remote participant, the video conference device exclusively uses its dedicated microphone to prevent echo signals from extended microphones. That is, the video conference device only provides audio signals from the dedicated microphone to remote devices. If the video conference device does not detect speech signals from remote participants, the video conference device evaluates the previous microphone usage status. If the previous status is that all microphones were in use, the video conference device maintains the status of using all the microphones. That is, the video conference device collects audio signals from all the microphones to process and provide to the remote participants. If the previous status is that only the dedicated microphone was in use, the video conference device determines presence of speech from local participants. If the video conference device does not detect speech from local participants, the video conference device maintains the status of only using the dedicated microphone. If the video conference device detects speech from a local participant, the video conference device switches to use all the microphones for better audio coverage.

Thus, a video conference device in a conference room dynamically selects or activates microphones to prevent echo signals from extended microphones while providing high-quality speech audio from local participants to remote participants by using both the dedicated microphone and the extended microphones.

This illustrative example is given to introduce the reader to the general subject matter discussed herein and the disclosure is not limited to this example. The following sections describe various additional non-limiting examples and examples of AEC for multi-microphone conference systems.

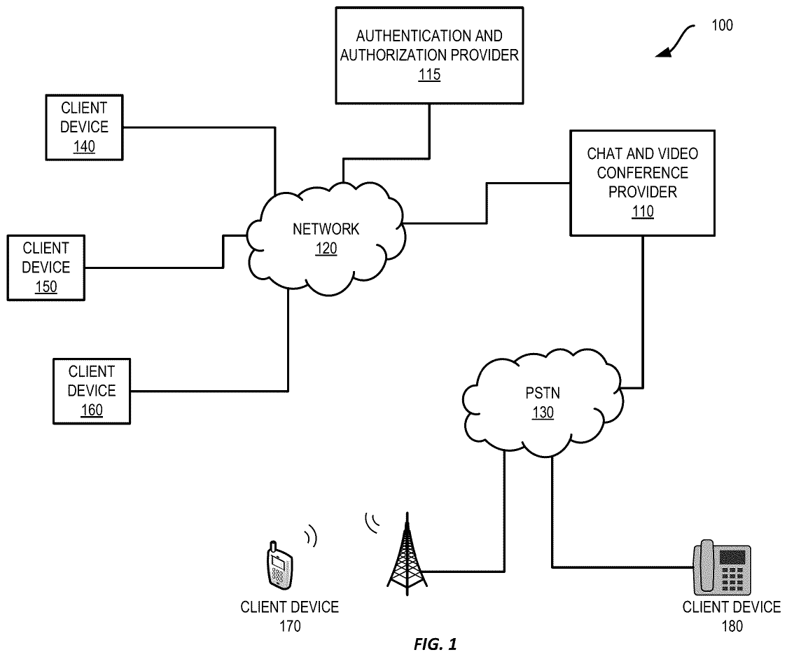

Referring now to FIG. 1, FIG. 1 shows an example system 100 that provides chat and videoconferencing functionalities to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

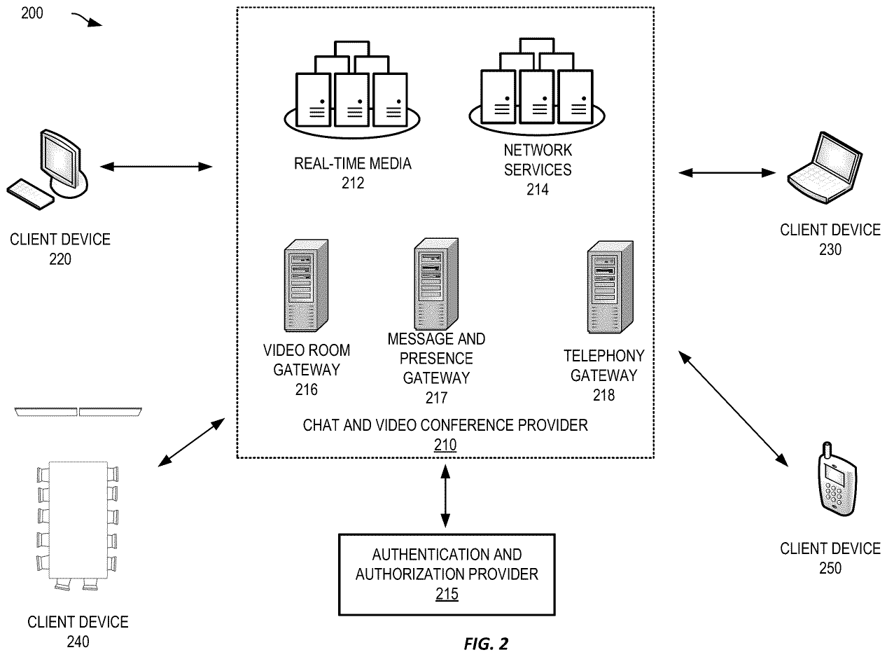

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides chat and videoconferencing functionalities to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

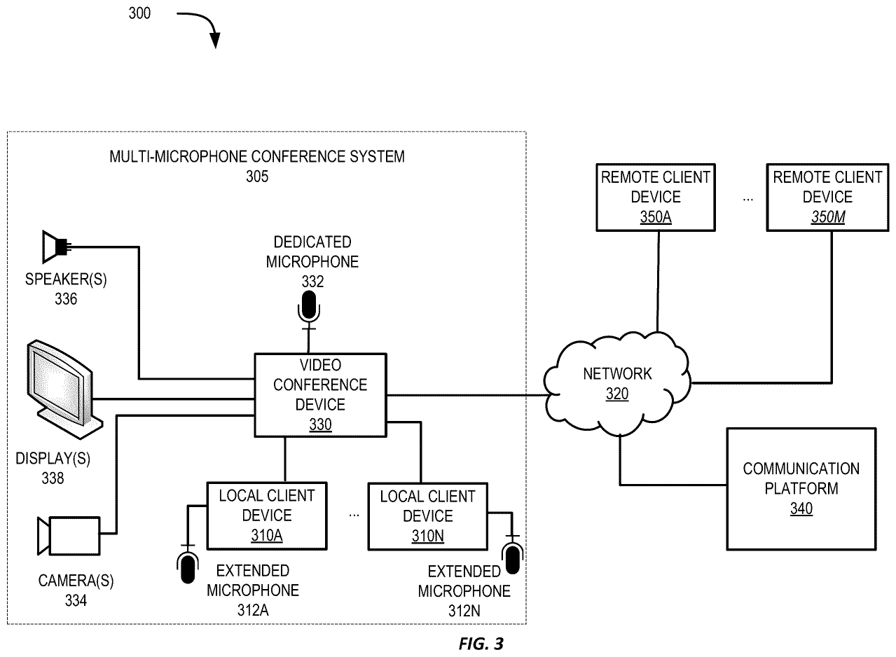

Referring now to FIG. 3, FIG. 3 shows an example system 300 for establishing a hybrid communication session. In this example system 300, a video conference device 330 in a conference room and a number of remote client device 350A-350M (which may be referred to herein individually as a remote client device 350 or collectively as the remote client devices 350) are connected to a communication platform 340 via a network 320. In this example, the network 320 is the internet, however, any suitable communications network or combination of communications network may be employed, including LANs (e.g., within a corporate private LAN) and WANs, similar to the network 120 illustrated in FIG. 1. The communication platform 340 can be the chat and video conference provider 110 illustrated in FIG. 1 or the chat and video conference provider 210 illustrated in FIG. 2. The remote client devices 350 can be client devices 140-160 illustrated in FIG. 1 or client devices 220, 230, or 250 illustrated in FIG. 2.

In this example, the video conference device 330 provides video conferencing functionality in a common area, such as a conference room. The video conference device 330 in this example includes a computing device. The video conference device 330 also includes or is connected with a dedicated microphone 332, one or more cameras 334, one or more speaker devices 336, and one or more displays 338, which are either embedded with the video conference device or installed within the conference room. While the video conference device 330 operates as a client device, its hardware components may be dispersed throughout the conference room to enable remote participants to hear local participants and enable local participants to hear remote participants.

The video conference device 330 has video conferencing software installed to enable it to communicate with the communication platform 340 and establish a hybrid communication session. The video conference device 330 captures audio and video data using the dedicated microphone 332 and the one or more cameras 334, and exchanges audio and video streams with remote participants via the communication platform 340. The dedicated microphone 332 are considered built-in microphones for the video conference device 330. While the video conference device 330 in some examples may include dedicated video conferencing equipment as discussed above, in other examples, it may be a conventional computing device, such as a desktop or laptop computer, or a handheld device such as a tablet or smartphone. During the hybrid communication session, the remote participants, via their respective remote client devices 350, are able to interact with each other and local participants by viewing video streams and hearing audio streams from other participants, and by capturing and transmitting video and audio of themselves.

In some examples, local participants bring their personal devices, such as laptops or smartphones, to the conferences. The personal devices associated with the local participants are local client devices 310A-310N (which may be referred to herein individually as a local client device 310 or collectively as the remote client devices 350). A local client device 310 includes or is connected with one or more microphones, such as microphone 312A associated with client device 310A and microphone 312N associated with client device 310N, which may be referred to herein individually as a microphone 312 or collectively as the microphones 312. The local client device 310 is also installed with a communication application provided by the communication platform 340.

In some examples, the local client device 310 is paired to the video conference device 330, such as via Bluetooth, or otherwise connected to the video conference device 330, such as over WiFi or another wireless networking technology. The video conference device 330 recognizes the microphone associated with the local client device 310 as a companion device and its microphone as a companion microphone or extended microphone 312. The video conference device 330 with its dedicated microphone 332, speaker devices 336, displays 338, cameras 334, and the extended microphones 312 at the local client devices 310 form a multi-microphone conference system 305.

If a local participant speaks during the hybrid communication session, the extended microphone 312 associated with the corresponding local client device 310 captures audio signals, and the corresponding local client device 310 transmits audio packets to the video conference device 330 via network communication to enhance audio quality. The speaker devices 336 associated with the video conference device 330 play audio signals from a remote client device 350A associated with a remote participant to allow local participants in the conference room to hear the remote participant. The audio played by the speaker devices 336 is captured as echo signals by both the dedicated microphone 332 of the video conference device 330 and the extended microphones 312 from the local client devices 310 in the conference room, all of which can send the echo signals back to the remote client devices 350, causing feedback.

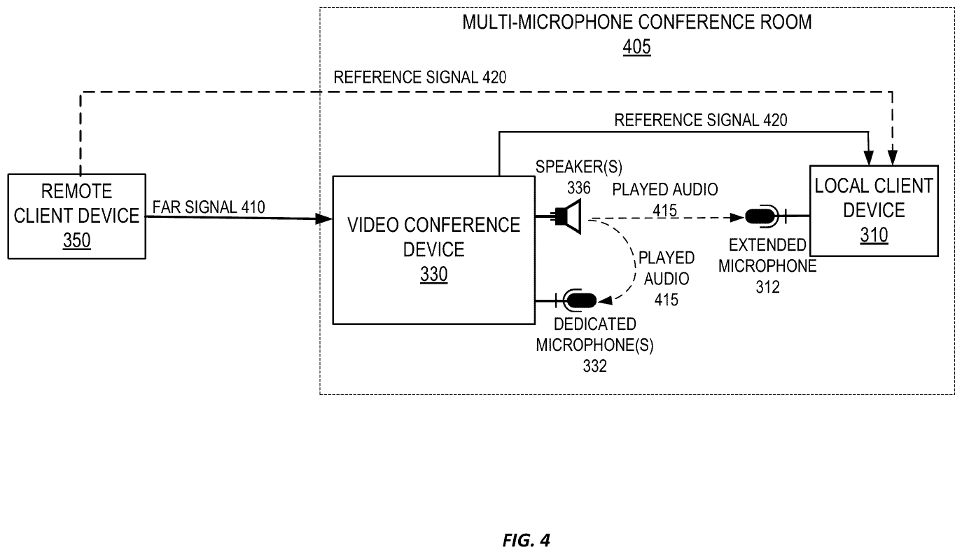

Now referring to FIG. 4, FIG. 4 shows a signal flow associated with a multi-microphone conference system when a remote participant of a video conference is speaking. A conference room is installed with a video conference device 330, which includes its dedicated microphone 332. One or more local participants are present in the conference room with their local client devices 310, for example laptops or mobile devices. The local client devices 310 are connected to the video conference device 330 via a local network. The microphones included in the local client devices 310 are extended microphones 312 for the video conference device 330. Thus, the video conference device 330, its dedicated microphone 332, and the extended microphones 312 from the local client devices 310 form a multi-microphone conference system 305 for the conference room, which can be called a multi-microphone conference room 405.

In FIG. 4, an audio signal from a remote client device 350 associated with a remote participant, referred to as a far signal (or far speech) 410, is sent to the video conference device 330. An audio signal from a local participant in the multi-microphone conference room 405 is referred to as a near signal (or near speech). After the video conference device 330 receives the far signal 410, it plays the audio through its speaker devices 336, allowing local participants to hear the remote participant. Simultaneously, the played audio is captured by both the dedicated microphone 332 and extended microphones 312 in the multi-microphone conference room 405.

Without any AEC at the video conference device 330, the far signal 410 captured by all the multiple microphones would be sent back to the remote client device 350, causing the remote participant to hear his/her own voice as an echo. Such echo disrupts communication and degrades user experience.

Conventional AEC techniques require a reference signal to arrive before the corresponding echo to be canceled. This requirement is always met in a single-microphone conference system because the system plays the audio only after receiving it, ensuring that any echo captured by the microphone occurs later than the received audio, which is the reference signal. Such a system is known as a causal system. However, in a multi-microphone conference system, such a requirement may not always be met. For example, a local client device 310 receives the reference signal from the video conference device 330 after an extended microphone at the local client device 310 captures echo from the speaker devices 336 of the video conference device 330 before. Thus, the conventional AEC techniques do not work effectively for a multi-microphone conference system.

As illustrated in FIG. 4, the far signal 410 is transmitted to the video conference device 330. The video conference device 330 then receives the far signal 410 and plays the audio 415 through the speaker devices 336, allowing local participants to hear the remote participant. The played audio 415 is captured by both the dedicated microphone 332 at the video conference device 330 and the extended microphones 312 in the conference room. The video conference device 330 transmits the reference signal 420 to the extended microphone 312. Alternative, the reference signal 420 can be directly received from the remote client device 350. In the example audio flow in FIG. 4, the video conference device 330 itself operates as a causal system, because the far signal 410 as the reference signal from the remote participant before the dedicated microphone 332 and the extend microphones 312 captures the played audio 415 from the speaker devices 336.

However, an extended microphone 312 may function as a non-causal system, because the local client device 310 may receive the reference signal 420 from the video conference device 330 or the remote client device 350 before or after the extended microphone 312 receives the played audio 415, depending on network conditions. In some examples, the extended microphone 312 captures the echo before receiving the reference signal 420, making it a non-causal system where the traditional AEC techniques fail.

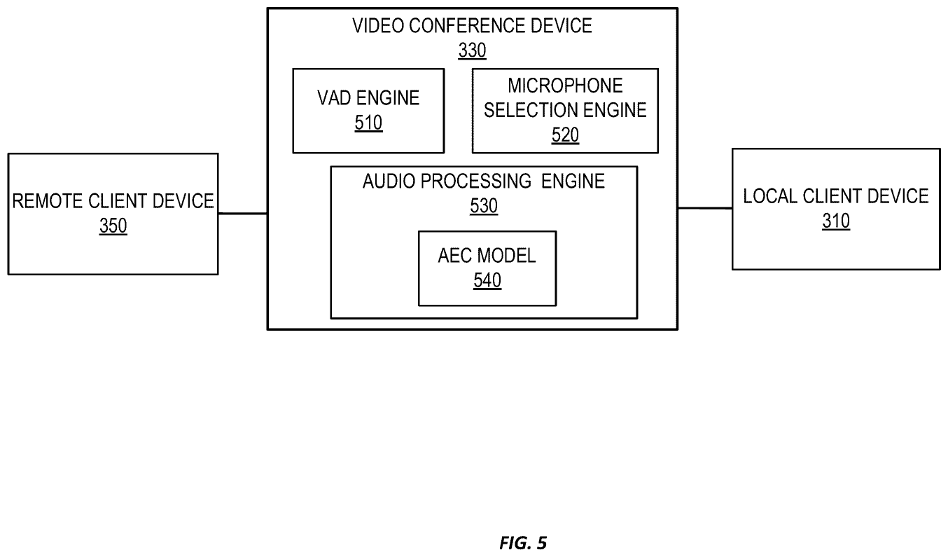

Now referring to FIG. 5, FIG. 5 shows an example system that is configured for AEC in a multi-microphone conference system. One or more remote client devices 350 are connected with a video conference device 330 installed in a conference room via network communication. Meanwhile, one or more local client devices are connected to the video conference device 330 via local network in the conference room.

The video conference device 330 includes a voice activity detection (VAD) engine 510 configured to determine whether speech detected in a currently received audio signal is a far speech signal or a near speech signal, that is, whether the currently speaking participant is a local participant or a remote participant. In some examples, the video conference device 330 includes a near speech VAD model configured to detect speech signals from local participants and a far speech VAD model configured to detect speech signals from remote participants. In some examples, the VAD engine 510 includes one VAD model to determine whether an audio signal is from a remote participant or a local participant. The one or more VAD models use or implement deep learning algorithms, for example convolutional neural networks (CNNs), recurrent neural networks (RNNs), or transformer models, to detect whether the currently received audio signal is from a local participant or from a remote participant. Alternatively, or additionally, the one or more VAD models use feature extraction or statistical methods.

The VAD models determine whether an audio signal contains a far speech signal from a remote participant associated via a remote client device 350 or a near speech signal from a local participant based on distinct audio features or network characteristics. For example, near speech signals usually have a much higher direct energy level compared to the same sound played from a remote speaker and received by a local microphone. Near speech signals also contain more direct sound and less reflected room sound. In contrast, far speech signals often carry echoes or reverberation of the remote participant's local environment and processing artifact. In addition, far speech signals go through codecs and networks, which can alter spectral content, introduce compression artifacts, and add background noise. Besides, far speech signals may have network delays, jitters, and packet loss.

In some examples, the VAD engine 510 knows where the received audio signal is from, whether from an extended microphone or from the communication platform 340, based on the received channels. In other words, the VAD engine 510 knows whether the received audio signal is from a local client device 310 or a remote client device 350. Then the VAD engine 510 then uses a VAD model to determine whether the received audio signal includes speech or not. If the received audio signal includes speech, the VAD engine determines that a participant associated with the client device where the audio signal is received from is speaking, thereby determining whether the currently speaking participant is a remote participant or a local participant.

The video conference device 330 also includes a microphone selection engine 520 configured for dynamic microphone selection (or activation) based on whether the currently speaking participant is a local participant or a remote participant, as determined by the VAD engine 510. In some examples, a microphone being selected (or activated) for use means that audio signals from the selected microphone are captured and processed and then provided to other devices, while audio signals from non-selected microphones are not captured, e.g., the microphone is deactivated, or otherwise are not used, e.g., the microphone remains active, but its audio stream is discarded. In some examples, a microphone being selected (or activated) for use indicates that the selected microphone is enabled and unmuted while the non-selected microphones are disabled or muted.

If the VAD engine 510 determines the currently speaking participant is a remote participant, that is, the audio signal is a far speech signal, the microphone selection engine 520 selects or activates only the dedicated microphone associated with the video conference device 330. If the VAD engine 510 determines the currently speaking participant is a local participant, the microphone selection engine 520 checks whether the previously activated microphones include the dedicated microphone only. If the previously activated microphones include all the microphones, the microphone selection engine 520 activates all microphones in the room, including the dedicated microphone and the extended microphones. If the previously activated microphones include the dedicated microphone only, the microphone selection engine 520 determines whether the previous speaking participant is a remote participant. If the previous speaking participant is a remote participant, the microphone selection engine 520 activates the dedicated microphone only. If the previous speaking participant is a local participant, the microphone selection engine 520 activates all the microphones in the room.

The video conference device 330 of the multi-microphone conference system also includes an audio processing engine 530 configured for processing audio signals from the activated microphones. The audio processing engine 530 includes an AEC model 540 configured to cancel echo signals captured by the dedicated microphone 332 of the video conference device 330. The AEC model 540 includes a linear DSP component to filter out linear echo components from the audio signals captured at the dedicated microphone 332 based on a reference signal from a remote microphone associated with a remote client device 350. The AEC model 540 correlates the echo signal with the reference signal, for example using a Pearson correlation formula, to determine if the echo signals and the reference signal are in a linear relationship. The linear DSP component can include a Kalman filter or a multidelay block frequency domain (MDF) adaptive filter for filtering out the linear echo components.

In some examples, the AEC model 540 also includes a non-linear filtering component. The non-linear filtering component can be a Wiener filter for filtering out nonlinear echo residuals in the filtered audio signal from the linear component. Alternatively, or additionally, the non-linear component can also be a trained AI model for filtering out nonlinear echo residuals in the filtered audio signal from the linear component. Suitable AI models include convolutional neural network (CNN) models or long short-term memory (LSTM) models. For example, a U-Net, which is a type of CNN model, can be trained with different sets of training data from different environments to create one or more trained AI models.

The audio processing engine 530 also uses or implements a smoothing function, for example a cosine function, to smooth audio signals from selected microphones to ensure the audio signals are natural and do not disrupt user experience. For example, during a microphone switching process from only using the dedicated microphone 332 to using all the microphones including both the dedicated microphone 332 and the extended microphones 312, a smoothing region includes a period before the switching and a period after the switching. The smoothing function blends both the audio signals from the built-in microphone and the audio signals from the extended microphones.

In some examples, the one or more local client devices 310 includes a local AEC engine. In some examples, the one or more local client devices 310 does not include any local AEC engine. However, as the local AEC engine may only be useful when the remote participant is speaking and the microphone selection engine 520 only selects audio signals from the dedicated microphone when the remote participant is speaking, the local client device 310 no longer needs any local AEC engines.

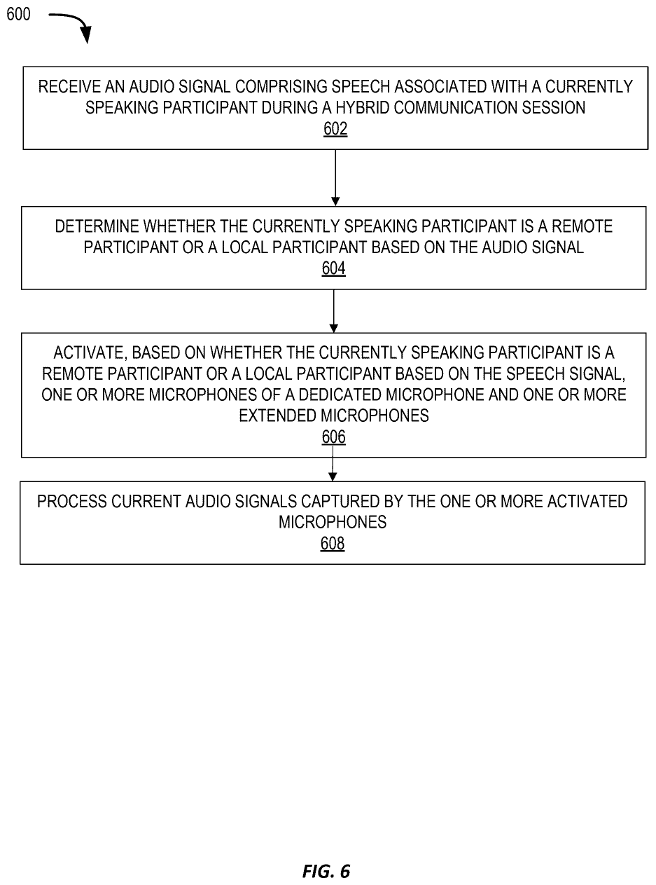

Now referring to FIG. 6, FIG. 6 shows an example method of AEC for a multi-microphone conference system. At block 602, a video conference device 330 receives an audio signal comprising speech. The speech is associated with a currently speaking participant during a hybrid communication session. The hybrid communication session is established between the video conference device 330 and one or more remote client devices 350. The hybrid communication session includes one or more local participants in a common area where the video conference device 330 is located. The hybrid communication session also includes one or more remote participants associated with the one or more remote client devices 350. The video conference device 330 includes one or more dedicated microphone 332 in the common area and one or more extended microphones related to one or more local client devices 310 associated with the one or more local participants.

At block 604, the video conference device 330 detects whether the currently speaking participant is a remote participant or a local participant based on the audio signal, generally as described in FIG. 5. For example, the VAD engine 510 of the video conference device 330 uses one or more VAD models to determine the audio signal is for a far speech from a remote participant or a near speech from a local participant in the common area based on audio features and network characteristics, such as energy levels, echo components, artifacts, and delays.

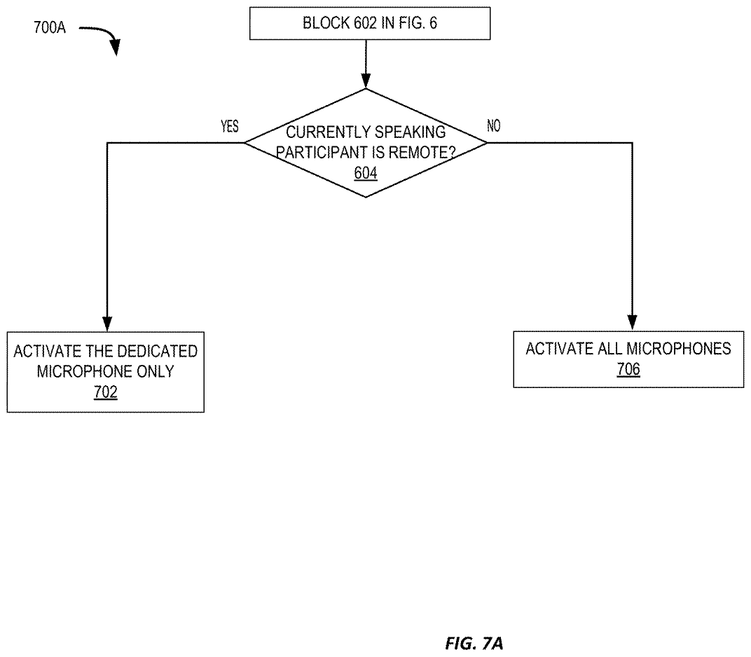

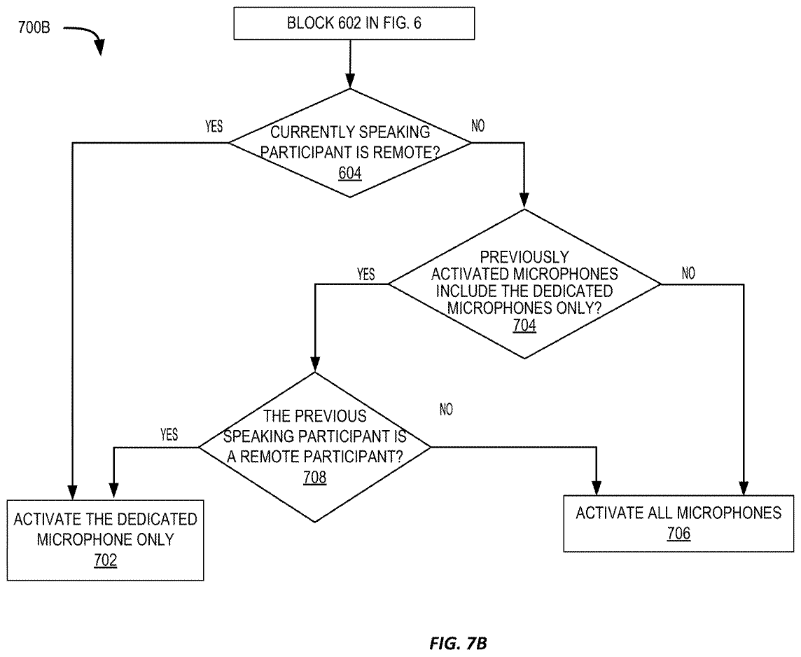

At block 606, the video conference device 330 activates, based on whether the currently speaking participant is a remote participant or a local participant, one or more microphones of the dedicated microphone and the one or more extended microphones, generally as described in FIG. 5. Example methods of adaptive microphone selection for AEC are also illustrated in FIG. 7A and FIG. 7B, as will be described below.

At block 608, the video conference device 330 processes audio signals captured by the one or more activated microphones. If the dedicated microphone 332 and the one or more extended microphones are all selected, the audio processing engine 530 of the video conference device 330 can process and mix the current audio signals from the microphones to create current audio streams to transmit to the remote client devices 350. In some examples, the video conference device 330 transmits the current audio streams to the communication platform 340, which then transmits the current audio stream to the plurality of remote client devices 350. If only the dedicated microphone 332 are activated, the audio processing engine 530 processes the current audio signals from the dedicated microphone 332 only, including AEC.

Now referring to FIG. 7A, FIG. 7A shows an example method 700A of adaptive microphone selection for AEC in FIG. 6. If at block 604 in FIG. 6, the VAD engine 510 of the video conference device 330 determines that the currently speaking participant is a remote participant, then at block 606, the microphone selection engine 520 activates the dedicated microphone 332 only, as shown in block 702 in FIG. 7A. That is, the video conference device 330 only selects audio signals from the dedicated microphone 332 to prevent far signal echo issues that the extended microphones may cause. If at block 604 in FIG. 6, the VAD engine 510 of the video conference device 330 determines that the currently speaking participant is a local participant, then at block 606, the microphone selection engine 520 activates the dedicated microphone 332 and the extended microphones 312, as shown in block 704 in FIG. 7A.

Now referring to FIG. 7B, FIG. 7B shows an example method 700B of adaptive microphone selection for AEC in FIG. 6. If at block 604 in FIG. 6, the VAD engine 510 of the video conference device 330 determines that the currently speaking participant is a remote participant, then at block 606, the microphone selection engine 520 activates the dedicated microphone 332 only, as shown in block 702 in FIG. 7B. That is, the video conference device 330 only selects audio signals from the dedicated microphone 332 to prevent far signal echo issues that the extended microphones may cause.

If at block 604 in FIG. 6, the VAD engine 510 determines that the currently speaking participant is a local participant, then at block 606, the microphone selection engine 520 further determines whether previously activated microphones include the dedicated microphone only, as shown at block 704. If the previously activated microphones does not only include the dedicated microphone 332 but also one or more extended microphones 312 associated with corresponding local client devices 310, the microphone selection engine 520 activates all the microphones, including the dedicated microphone 332 and the extended microphones 312, as shown in block 706.

If the previously activated microphones include the dedicated microphone 332 only, the microphone selection engine 520 further determines whether the previously speaking participant is a remote participant, as shown in block 708. If the previously speaking participant is a remote participant, the microphone selection engine 520 activates the dedicated microphone 332 only, as shown in block 702. If the previously speaking participant is a local participant, the microphone selection engine 520 activates all the microphones, including the dedicated microphone 332 and the extended microphones 312, as shown in block 706.

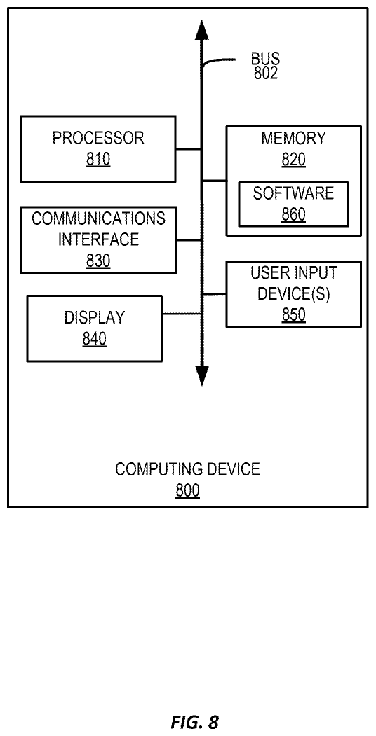

Referring now to FIG. 8, FIG. 8 shows an example computing device 800 suitable for use in example systems or methods of AEC for a multi-microphone conference system according to this disclosure. The example computing device 800 includes a processor 810 which is in communication with the memory 820 and other components of the computing device 800 using one or more communications buses 802. The processor 810 is configured to execute processor-executable instructions stored in the memory 820 to perform one or more methods of AEC for a multi-microphone conference system according to different examples, such as part or all of the example methods described above with respect to FIG. 6, FIG. 7A, and FIG. 7B. In some embodiments, the computing device 800 may include software 860 for executing one or more methods described herein, such as for example, one or more steps of methods 600, 700A, or 700B. The computing device 800, in this example, also includes one or more user input devices 850, such as a keyboard, mouse, touchscreen, microphone, etc., to accept user input. The computing device 800 also includes a display 840 to provide visual output to a user.

In addition, the computing device 800 includes software 860 to enable a user to join and participate in one or more virtual spaces or in one or more conferences, such as a conventional conference or webinar, by receiving multimedia streams from a virtual conference provider, sending multimedia streams to the virtual conference provider, joining and leaving breakout rooms, creating video conference expos, etc., such as described throughout this disclosure, etc.

The computing device 800 also includes a communications interface 830. In some examples, the communications interface 830 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving, by a video conference device located in a common area, an audio signal comprising speech, the speech being associated with a currently speaking participant during a hybrid communication session between the video conference device and one or more remote client devices, wherein one or more local participants are located in the common area and one or more remote participants are associated with the one or more remote client devices, and wherein the video conference device comprises a dedicated microphone in the common area and is communicatively coupled to one or more extended microphones related to one or more local client devices associated with the one or more local participants;
determining, by the video conference device, whether the currently speaking participant is a remote participant or a local participant based on the audio signal;
activating, by the video conference device based on whether the currently speaking participant is a remote participant or a local participant, one or more microphones of the dedicated microphone and the one or more extended microphones; and
processing, by the video conference device, audio signals from the one or more activated microphones.

2. The method of claim 1, further comprising:
determining that the currently speaking participant is a remote participant based on the audio signal; and
activating the dedicated microphone only.

3. The method of claim 1, further comprising:
detecting that the currently speaking participant is a local participant based on the audio signal; and
determining whether previously activated microphones include the dedicated microphone only.

4. The method of claim 3, further comprising:
in response to determining that the previously activated microphones include the dedicated microphone and the one or more extended microphones, activating the dedicated microphone and the one or more extended microphones.

5. The method of claim 3, further comprising:
in response to determining that the previously activated microphones include the dedicated microphone only, determining whether a previously speaking participant was a remote participant.

6. The method of claim 5, further comprising:
in response to determining that the previously speaking participant was a remote participant, activating the dedicated microphone only.

7. The method of claim 5, further comprising:
in response to determining that the previously speaking participant was a local participant, activating the dedicated microphone and the one or more extended microphones.

8. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
receive an audio signal comprising speech, the speech being associated with a currently speaking participant during a hybrid communication session between a video conference device and one or more remote client devices, wherein one or more local participants are located in a common area where the video conference device is located and one or more remote participants are associated with the one or more remote client devices, and wherein the video conference device comprises a dedicated microphone in the common area and is communicatively coupled to one or more extended microphones related to one or more local client devices associated with the one or more local participants;
determine whether the currently speaking participant is a remote participant or a local participant based on the audio signal;
activate, based on whether the currently speaking participant is a remote participant or a local participant, one or more microphones of the dedicated microphone and the one or more extended microphones; and
process audio signals from the one or more activated microphones.

9. The system of claim 8, wherein the one or more processors are configured to execute further processor-executable instructions stored in the non-transitory computer-readable medium to:
determine that the currently speaking participant is a remote participant based on the audio signal; and
activate the dedicated microphone only.

10. The system of claim 8, wherein the one or more processors are configured to execute further processor-executable instructions stored in the non-transitory computer-readable medium to:
detect that the currently speaking participant is a local participant based on the audio signal; and
determine whether previously activated microphones include the dedicated microphone only.

11. The system of claim 10, wherein the one or more processors are configured to execute further processor-executable instructions stored in the non-transitory computer-readable medium to:
in response to determining that the previously activated microphones include the dedicated microphone and the one or more extended microphones, activate the dedicated microphone and the one or more extended microphones.

12. The system of claim 10, wherein the one or more processors are configured to execute further processor-executable instructions stored in the non-transitory computer-readable medium to:
in response to determining that the previously activated microphones include the dedicated microphone only, determining whether a previously speaking participant was a remote participant.

13. The system of claim 12, wherein the one or more processors are configured to execute further processor-executable instructions stored in the non-transitory computer-readable medium to:
in response to determining that the previously speaking participant was a remote participant, activate the dedicated microphone only.

14. The system of claim 12, wherein the one or more processors are configured to execute further processor-executable instructions stored in the non-transitory computer-readable medium to:
in response to determining that the previously speaking participant was a local participant, activate the dedicated microphone and the one or more extended microphones.

15. A non-transitory computer-readable medium comprising processor-executable instructions configured to cause one or more processors to:
receive an audio signal comprising speech, the speech being associated with a currently speaking participant during a hybrid communication session between a video conference device and one or more remote client devices, wherein one or more local participants are located in a common area where the video conference device is located and one or more remote participants are associated with the one or more remote client devices, and wherein the video conference device comprises a dedicated microphone in the common area and is communicatively coupled to one or more extended microphones related to one or more local client devices associated with the one or more local participants;
determine whether the currently speaking participant is a remote participant or a local participant based on the audio signal;
activate, based on whether the currently speaking participant is a remote participant or a local participant, one or more microphones of the dedicated microphone and the one or more extended microphones; and
process audio signals from the one or more activated microphones.

16. The non-transitory computer-readable medium of claim 15, further comprising processor-executable instructions configured to cause one or more processors to:
determine that the currently speaking participant is a remote participant based on the audio signal; and
activate the dedicated microphone only.

17. The non-transitory computer-readable medium of claim 15, further comprising processor-executable instructions configured to cause one or more processors to:
detect that the currently speaking participant is a local participant based on the audio signal;
determine that previously activated microphones include the dedicated microphone and the one or more extended microphones; and
activate the dedicated microphone and the one or more extended microphones.

18. The non-transitory computer-readable medium of claim 15, further comprising processor-executable instructions configured to cause one or more processors to:
detect that the currently speaking participant is a local participant based on the audio signal;
determine that previously activated microphones include the dedicated microphone only; and
determining whether a previously speaking participant was a remote participant.

19. The non-transitory computer-readable medium of claim 18, further comprising processor-executable instructions configured to cause one or more processors to:
in response to determining that the previously speaking participant was a remote participant, activate the dedicated microphone only.

20. The non-transitory computer-readable medium of claim 18, wherein the one or more processors are configured to execute further processor-executable instructions stored in the non-transitory computer-readable medium to:
in response to determining that the previously speaking participant was a local participant, activate the dedicated microphone and the one or more extended microphones.
